(19) United States
(12) Patent Application Publication
(10) Pub. No.: US 2023/0304297 A1
(43) Pub. Date: Sep. 28, 2023

(54) METHODS FOR PREPARING DIMENSIONALLY STABLE FOAM BACKERS AND SIDING COMPRISING SAME

(71) Applicant: Progressive Foam Technologies, Inc., Beach City, OH (US)

(72) Inventors: Ryan Beach, New Philadelphia, OH (US); Jason L. Culpepper, Beach City, OH (US)

(21) Appl. No.: 18/126,195

(22) Filed: Mar. 24, 2023

Related U.S. Application Data
(60) Provisional application No. 63/323,526, filed on Mar. 25, 2022.

(51) Int. Cl. E04F 13/08; B32B 5/18; B32B 7/12

(52) U.S. Cl. CPC E04F 13/0876; B32B 5/18; B32B 7/12; B32B 2250/02; B32B 2266/08; B32B 2607/00; E04F 13/0864

(57) ABSTRACT

A composite siding panel mountable on an exterior wall of a building includes a foam backing member and a siding member attached to the backing member, such as through the use of an adhesive coating. The foam backing member is treated to be dimensionally stable. The resulting composite siding panel is less vulnerable to visual or other defects that may occur when the backing member is not dimensionally stable.

### CROSS-REFERENCE TO RELATED APPLICATIONS

This application claims priority to U.S. Provisional Pat. Application Serial No. 63/323,526, filed on Mar. 25, 2022, the entirety of which is hereby fully incorporated by reference herein.

### BACKGROUND

The present disclosure relates to composite siding panels for an exterior wall of a building such as a house. Such composite siding panels include a siding member attached to a foam backing member. Methods and processes for making and/or using backing members with increased dimensional stability are also disclosed herein, as well as siding panels comprising the same.

Composite siding panels are known in the art. In many traditional composite siding panels, a siding member (e.g. vinyl) is attached to a foam backing member. In some embodiments, an adhesive is applied to the front of the foam backing member to secure the backing member to the siding member.

### BRIEF DESCRIPTION

It has been found that poor dimensional stability of the foam backing member can cause undesired expansion, shrinkage, and/or buckling of the composite siding panel. To address these problems, disclosed in various embodiments herein are various methods for obtaining foam backing members with good dimensional stability.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a right side perspective view of a composite siding panel. The composite siding panel includes a siding member and a backing member.

FIG. 2A is a front perspective view of the composite siding panel of FIG. 1. FIG. 2B is a rear perspective view of the composite siding panel of FIG. 1.

FIG. 3A is a side view of a siding member of the composite siding panel of FIG. 1. The siding member includes contours that are substantially complementary to the contours of the backing member. FIG. 3B is a side view of a backing member of the composite siding panel of FIG. 1. The backing member includes contours that are complementary to the contours of the siding member.

### DETAILED DESCRIPTION

A more complete understanding of the components, panels, assemblies, and processes disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments. In the drawings and the following description below, it is to be understood that like numeric designations refer to components of like function.

The present disclosure may be understood more readily by reference to the following detailed description of desired embodiments and the examples included therein. In the following specification and the claims which follow, reference will be made to a number of terms which shall be defined to have the following meanings.

The singular forms “a,” “an,” and “the” include plural referents unless the context clearly dictates otherwise.

The term “comprising” is used herein as requiring the presence of the named components/steps and allowing the presence of other components/steps. The term “comprising” should be construed to include the term “consisting of”, which allows the presence of only the named components/steps, along with any impurities that might result from the manufacture of the named components/steps.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “substantially” and “about” can be used to include any numerical value that can vary without changing the basic function of that value. When used with a range, “substantially” and “about” also disclose the range defined by the absolute values of the two endpoints, e.g. “about 2 to about 4” also discloses the range “from 2 to 4.” The terms “substantially” and “about” may refer to plus or minus 10% of the indicated number.

The present disclosure refers to components as having a length, width, height, and thickness. It is noted that “length” and “width” are used interchangeably herein, or put another way, these terms refer to the same dimension or axis.

It should be noted that many of the terms used herein are relative terms. For example, the terms “upper” and “lower” are relative to each other in location, i.e. an upper component is located at a higher elevation than a lower component in a given orientation, but these terms can change if the device is flipped. The terms “horizontal” and “vertical” are used to indicate direction relative to an absolute reference, i.e. ground level. The terms “above” and “below”, or “upwards” and “downwards” are also relative to an absolute reference; an upwards flow is always against the gravity of the earth.

The term “parallel” should be construed in its lay term as two edges or faces generally continuously having the same distance between them, and should not be strictly construed in mathematical terms as requiring that the two edges or faces cannot intersect when extended for an infinite distance. Similarly, the term “planar” should not be strictly construed as requiring that a given surface be perfectly flat.

The present disclosure may refer to temperatures for certain method steps. It is noted that these references are to the temperature at which the heat source is set, and do not specifically refer to the temperature which must be attained by a particular material being exposed to the heat.

The term “room temperature” means a temperature from 20° C. to 25° C. (68° F. to 77° F.). The term “ambient temperature” refers to the temperature of the surrounding area when not controlled.

Composite siding panels usually include a backing member and a siding member. The backing member has a front face, a rear face opposite the front face thereof, and longitudinally-extending first and second side faces. Rear side edges are present at the intersection of the rear face with each side face, and front side edges are present at the intersection of the front face with each side face. In turn, the siding member has a front face, a rear face opposite the front face thereof, and longitudinally-extending first and second side edges. The rear face of the siding member is in overlying relationship with and attached to the front face of the backing member such as by an adhesive coating. The adhesive coating is located between the siding member and the backing member.

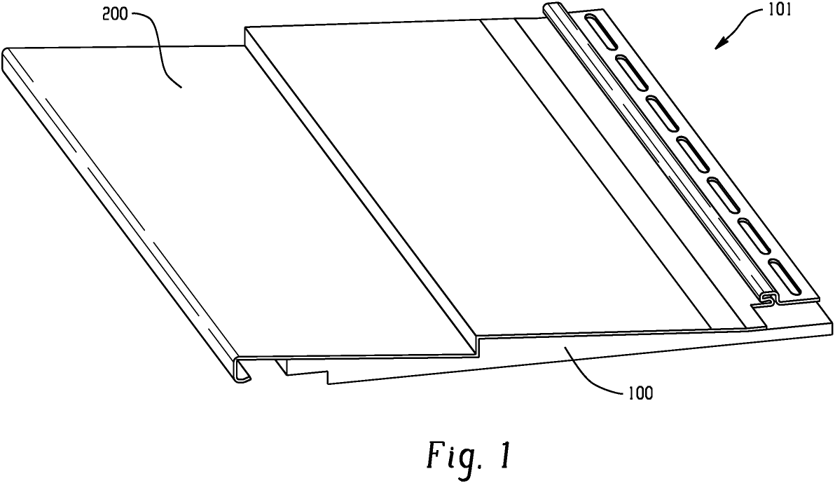

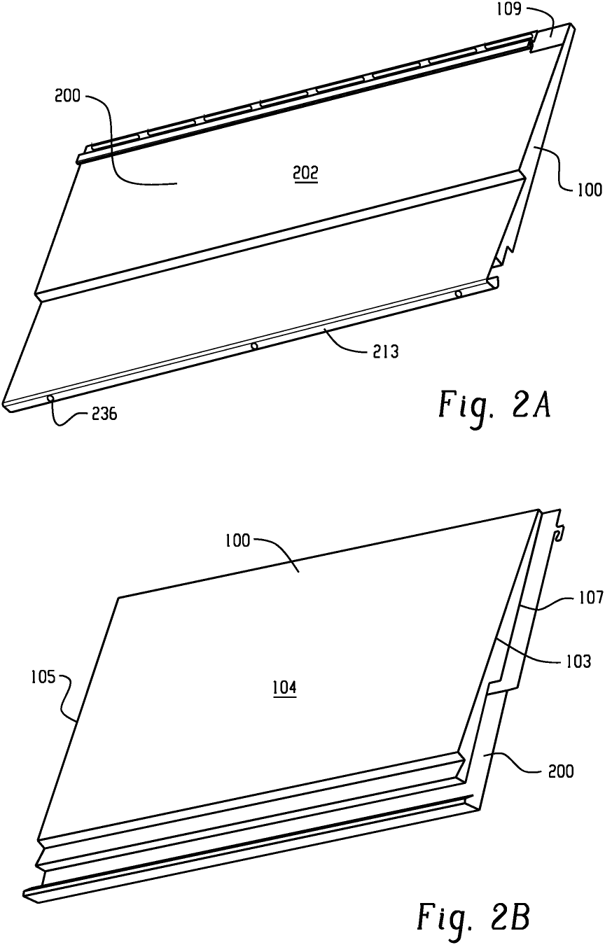

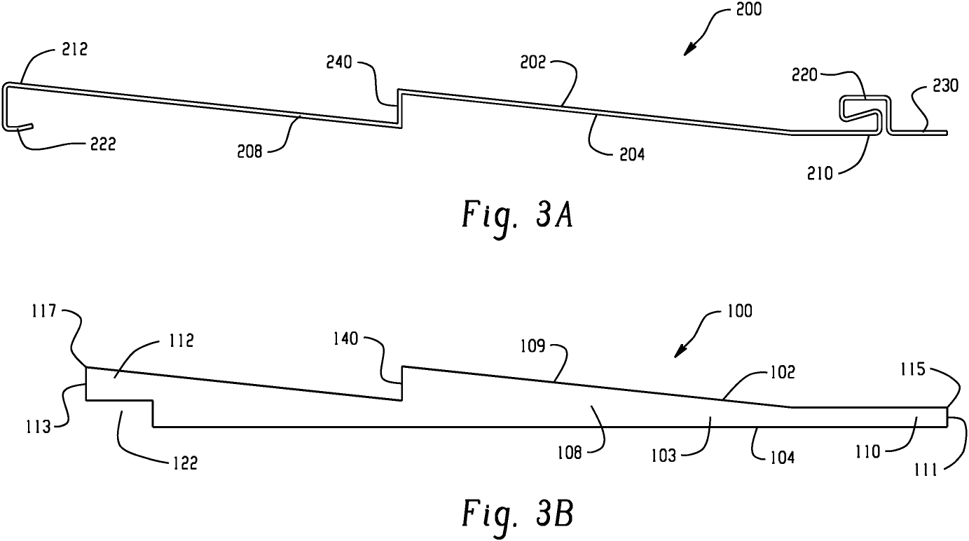

An example of a composite siding panel suitable for use in the present application is illustrated in FIG. 1, FIGS. 2A-2B, and FIGS. 3A-3B.

FIG. 1 shows an improved composite siding panel 101 according to the present disclosure, which includes a foamed backing member 100 and a siding member 200. As can be seen in FIG. 2A and FIG. 2B, the siding member 200 is in overlying relationship with and attached to the backing member 100. As can be further seen in FIG. 2A, the bottom face 213 of the siding member 200 can include several drainage holes 236 for expelling water or moisture that may be present behind the siding member 200 once the composite siding panel 101 is installed. It is noted that composite siding panels are typically several feet in length, and that they are depicted in these figures as being shorter for illustrative purposes only (so that both sides can be seen).

FIG. 3A illustrates certain features of an exemplary siding member 200 according to one embodiment of the present disclosure. The siding member 200 has a front face 202 and a rear face 204, which are located opposite each other. The siding member 200 also includes longitudinally-extending first and second side edges, which generally extend parallel to one another.

As illustrated here, the siding member 200 of this exemplary embodiment includes a locking flange 220 proximate a top end 210 of the siding member 200. The siding member 200 of this exemplary embodiment further includes a locking lip 222 proximate a bottom end 212 of the siding member 200. The locking flange 220 is complementary in shape to the locking lip 222. In this way, the locking flange 220 can operably engage or cooperate with the locking lip 222 of another siding member stacked above it.

FIG. 3B illustrates certain features of an exemplary backing member 100 according to the present disclosure. The foamed backing member 100 has a front face 102 and a rear face 104, located opposite each other. The rear face 104 is planar, such that it is mountable on another planar surface, such as an exterior wall of a building. The backing member 100 includes longitudinally-extending first and second side faces. Front side edges 107, 109 (see FIG. 2A and FIG. 2B) are present at the intersection of the front face 102 with each side face. For example, first front side edge 107 is present at the intersection of the front face 102 with the first side face, and second side edge 109 is present at the intersection of the front face 102 with the second side face 108. The first and second side faces of the backing member 100 are generally planar and extend parallel to one another.

The backing member 200 of this exemplary embodiment includes a laterally-extending relief channel 122 defined in the rear face 104 and located proximate a bottom end 112 of the backing member 100. The relief channel 122 generally runs from the first side face to the second side face of the backing member 100 (i.e., from a first rear side edge 103 to a second rear side edge 105 of the backing member, as seen in FIG. 2B) and is configured to be complementary to the top end 110 of a longitudinally adjacent backing member located below it, or in other words so the top end fits in the relief channel 122 (see FIG. ). In this embodiment, they are shaped in the form of a tongue 110 and a groove 122, which are used to join adjacent panels together vertically. The backing member 100 also has a contour 140 defined therein. As can be seen with reference to FIG. 3A, the siding member 200 has one or more substantially complementary-shaped contours 240 defined therein. In this way, the siding member 200 can be configured to be in overlying relationship with the backing member 100 and be closely attached thereto without any gap present therebetween. It is contemplated that the backing member 100 and the siding member 200 may have any suitable configuration desired or required to impart the aesthetic look desired. Put another way, the front face 102 of the backing member 100 can be angled with respect to the rear face 104 of the backing member 100.

The composite siding panel may be vulnerable to visual defects or abnormalities, especially where one panel overlaps with another panel. It is desired to minimize such visual defects. It has been discovered that a lack of dimensional stability in the foam backing member contributes to such visual defects. The present disclosure thus relates to methods for improving the dimensional stability of the foam backing member in part by controlling the release of its moisture content.

Very generally, a freshly molded block of foam material is first produced. Then, when certain conditions are met, the block of foam material is cut into a desired shape to form a foam backing member. Next, the foam backing member is treated and conditioned by various processes and environments to achieve overall dimensional stability. The composite siding panel can then be made from the dimensionally stable foam backing member, typically by lamination (to apply adhesive) and then attachment of the siding member.

In this regard, dimensional stability refers to the fact that the foam blocks (from which the foam backing member is made) can change shape slowly over time after being molded. This may occur due to stresses or strains present in the foam. Dimensional stability can be achieved when the foam is subsequently shaped /cut and conditioned so that the length of the foam backing member passively changes (i.e. decreases in length) at least 0.15% and/or the moisture content of the foam backing member is less than 1 wt%. In more desirable embodiments, the length of the foam backing member changes in a range of from 0.15% to about 0.3%.

In this regard, the foam is typically manufactured in the form of a large block, which is subsequently cut up to obtain one or more foam backing members. In particular embodiments, the foam is a closed-cell expanded foam, such as a polymeric foam like expanded polystyrene (EPS) foam. Beads of polystyrene are first pre-expanded using steam heating and allowed to rest for a suitable interval, then molded in closed steam-heated shaped molds to produce a large molded foam block. When removed from the mold, the foam block typically has a moisture content of more than 6 wt% (based on the total weight of the foam block). Even after 48 hours, the moisture content is usually 5 wt% or more.

Optionally, the large foam block itself may first be aged slightly by sitting or resting before being cut up. The aging of the foam block may occur at ambient temperature, and in more particular embodiments any temperature ranging from room temperature to a temperature of up to about 150° F. or about 145° F. (~63° C.). In some embodiments, the aging occurs at a temperature of about 130° F. to about 145° F. (~54° C. to ~63° C.), or from about 130° F. to about 150° F. The aging of the foam block may occur for a time period of from about 1 day (about 24 hours) to about 20 days (about 480 hours).

Next, the foam block is processed, here cut, to obtain one or more foam backing members 100 having the desired shape or size, as will be appreciated by those skilled in the art, and usually has an initial length of several feet. For example, in some embodiments, the foam backing member has an initial length of about 10 feet to about 18 feet (about 120 inches to about 216 inches). The backing member made of “fresh” foam can be shaped by cutting the larger piece of foam block to a desired shape, for example through wire-cutting. In this regard, the backing member is cut to substantially match the shape of the siding member (which is usually polymeric, and which has a rigid shape). Generally, multiple foam backing members can be obtained from a single foam block. At this point, the moisture content of the foam block and the resulting foam backing member is usually about 3 wt% to about 4 wt%.

In the methods of the present disclosure, the recently cut foam backing member is thereafter further treated or aged to achieve dimensional stability. Put another way, the “freshly cut” foam backing member is further conditioned in a controlled environment to relieve internal stresses and strains. For purposes of this application, a foam backing member may be considered “freshly cut” if it has been cut from a larger foam block within the past 48 hours. The aging may occur under certain environmental conditions and temperatures. In more particular embodiments, the aging occurs at a temperature ranging from room temperature to a temperature of up to about 150° F. or about 145° F. (~63° C.). In some embodiments, the aging occurs at a temperature of about 130° F. to about 145° F. (~54° C. to ~63° C.), or from about 130° F. to about 150° F. The aging may occur for a time period of from about 3 days (about 72 hours) to about 30 days (about 720 hours). It is noted that the aging treatment can be different between different pieces of foam backing. For example, the foam can be aged for a shorter period of time at a relatively higher temperature, or can be aged for a longer period of time at a relatively higher temperature. The relative humidity should be low enough for any moisture present in the foam backing member to exit the foam backing member.

In specific embodiments, the foam backing member is considered to be dimensionally stable once its length has changed by at least 0.15%. More specifically, the length of the foam backing member should decrease by at least 0.15%. In more particular embodiments, the foam backing member is considered to be dimensionally stable once its length has changed (i.e. decreased) by at least 0.15% to about 0.30%. In some embodiments, the total change in length ranges from 0.25 inches to 0.625 inches.

In some very broad general embodiments, the time period in which this change of length is obtained may vary. For example, the time period can be one day, or two days, or three days, or four days, or five days, or six days, or seven days, or 10 days, or 20 days, or 22 days. The foam backing member can be considered dimensionally stable once the change in length has occurred, regardless of the number of days.

In some particular embodiments, the aging occurs for a time period of about 3 days to about 7 days at a temperature of about 130° F. to about 150° F. However, in other particular embodiments, the aging occurs for a time period of about 3 days to about 5 days at a temperature of about 130° F. to about 145° F. In other words, the aging at this elevated temperature continues for the specified amount of time even if the change in length is obtained earlier.

In other specific embodiments, the aging occurs for a time period of about 20 days to about 30 days at ambient temperature, and in more particular embodiments at room temperature. In other words, the aging continues for this specified amount of time even if the change in length is obtained earlier. In some specific embodiments, the minimum time for aging at ambient temperature or room temperature is 21 days, even if the length of the foam backing member changes by at least 0.15% in a shorter period of time. The length of the foam backing member may change in a range of from 0.15% to about 0.3% during this minimum time period of 21 days. After the foam backing member has been aged, the moisture content of the foam backing member is less than 1 wt%.

Prior to the aging, the dimensions of the foam backing member should be measured to provide a baseline for determining when dimensional stability has been achieved. It is contemplated that during the aging process, the dimensions of the foam backing member may be checked multiple times, and the various aging parameters (e.g. temperature, time) may be changed as needed to obtain the final desired dimensional stability. In particular embodiments, the length of the foam backing member is measured several times over the first three days of aging, and the longest (or maximum) measured length is used as the initial length, from which the change in length that determines dimensional stability is computed. This may be due to measurement error or other factors that can cause the length of the foam backing member to increase in the first few days.

The desired dimensional stability is obtained when the growth or shrinkage of the foam backing member has reached an insignificant level. The foam backing member can then be laminated to the siding member. This process ensures the optimal appearance of insulated vinyl siding or reinforced vinyl siding products, particularly where one panel overlaps another panel.

The aging can be performed by placing the foam backing member in an oven or heated room or similar device. In some embodiments, a conveyor belt or similar means for moving foam backing members through the oven may be used as well. The foam backing member should be supported such that the maximum surface area is exposed. It is desirable that the foam backing member should be heated / aged as evenly as possible. The environment within the oven is generally ambient air, suitably controlled to manage the relative humidity as desired for enhancing drying. Suitable mechanical and electronic controllers and sensors are present as well, and computers can be used to manage the aging process.

As mentioned, the backing member is comprised of a foam-based material. The foam is formed by trapping pockets of gas in a liquid or solid material. In most foams, the volume of gas is large, with thin films of liquid or solid separating the pockets of gas. The pockets can be closed-cell or open-cell. In a closed-cell foam, the gas forms discrete pockets, each completely surrounded by solid material. In an open-cell foam, the gas pockets are connected to each other. The gas pockets can vary in size, shape, and structure. Examples of suitable foam materials include foams comprising polyurethane, polystyrene, etc.

Continuing, it is contemplated that various cellular plastics can be employed as the material for the foam backing members disclosed herein. As used herein, the term(s) “cellular foam” or “cellular foam plastic” are taken to mean a plastic or polymeric material with numerous cells of trapped air distributed throughout its mass. Suitable examples of such materials can also be referred to as expanded plastics or foamed plastics with expanded polystyrene foam being but one non-limiting example.

“Expanded polystyrene foam” as used herein refers to cellular foam plastic made from polystyrene typically by incorporation of a volatile blowing agent into polystyrene beads as they are polymerized or afterward. In expanded polystyrene, beads of polystyrene are first pre-expanded and allowed to rest for a suitable interval, then molded in closed steam-heated shaped molds to produce closed-cell molded foams. The size and density of the closed cells can vary from application to application.

In this regard, it is believed that the early cutting and conditioning process permits early outgassing of residual moisture from the foam backing member in a more controlled manner. It is noted that the foam backing member must be early cut and then aged to obtain dimensional stability, in that order. For example, simply aging the foam block and then later cutting the foam block into foam backing members does not result in foam backing members which are dimensionally stabilized - rather, such foam backing members may continue to shrink in length.

The backing members of the present disclosure can have a tough, durable, smooth skin on the outer surface of the front and rear faces as well as any ends, edges, and additional surfaces. It is contemplated that the siding member may be traditional vinyl veneer material at thickness measuring from about 0.020 to about 0.036 inches. Various other polymeric or coating materials as would be cost effective can be used.

The backing member can also have various three-dimensional features located on one or more of the front face, rear face, top end, bottom end, or side edges as would be suitable for the associated composite siding panel. The three-dimensional features can include but are not limited to ridges, grooves, indents, detents and the like. Such geometric features can be imparted in a single operation by the shape molding process.

The backing member can also be pigmented as desired or required. In situations where the siding member is extremely thin, it is contemplated that the backing member can be pigmented to complement the color of the extremely thin siding member.

Next, the siding member 200 can be any desired shape or size, as will be appreciated by those skilled in the art, and usually have a length of several feet. In this regard, the siding member 200 can have any suitable configuration, profile, or contour suitable for a given application. The siding member 200 can be formed from any suitable material, namely a material suitable as an aesthetic outer surface of a building or the like. In particular embodiments, the siding member 200 can be formed of vinyl, polypropylene, aluminum, steel, fiberglass, engineered wood, or fiber cement, or other polymeric materials. It is contemplated that the siding member 200 could have some other veneer profile. It is contemplated that the siding member 200 will be composed of a suitable polymeric material, with vinyl materials being particularly suitable. The siding member 200 can have any suitable thickness, which is usually less than 0.1 inches. Usually, the structural strength of the backing member 100 is such that the need for structural strength and integrity of the siding member 200 is minimized. It is contemplated that the siding member 200 can be composed of any suitable sheet or film stock material. Materials of choice typically will be materials resistant to extremes in the external environment over the life of the siding system. Non-limiting examples of environmental challenges include extremes in temperature, prolonged exposure to ultraviolet light, and/or certain levels of impact and vibrational challenges due to wind and the like. In this regard, it is contemplated that the siding member 200 will be composed of any suitable polymeric, metal, plastic (e.g., fiber-reinforced plastic), composite wood, or cementitious material capable of providing suitable environmental resistance and durability.

The siding member 200 can be attached to the backing member 100 in a wide variety of fashions. In the present disclosure, an adhesive is used to laminate the siding member 200 and backing member 100 together, though other non-limiting examples of attachment include procedures such as the use of mechanical fasteners and/or chemical bonding at any location either prior to or during installation. The methods can be mixed as desired or required.

Because they are to be attached to each other, the rear face 204 of the siding member 200 is generally shaped complementary to the front face 102 of the backing member 100, as previously explained. It is contemplated that the backing member 100 can be shaped to have a suitable configuration complementary to the configuration of the siding member 200 Suitable configurations are depicted in the various drawings, though other suitable configurations are possible, as will be appreciated by those skilled in the art. The degree of correspondence between the shape of the siding member 200 and the shape of the backing member 100, including any contours defined in either, can be at any degree from approximate to exact depending on various factors, including but not limited to the material type and/or thickness of the siding member 200.

Where adhesive materials are to be employed, the adhesive can be applied by any suitable method. An adhesive coating can be located between the siding member and the backing member. Put another way, an adhesive coating joins the rear face of the siding member to the front face of the backing member. The coating can be continuous or discontinuous. The adhesive material can be applied as one or more beads, ribbons, dots, or swirls. The adhesive can also be applied in a thin layer or the like. In certain applications, it is contemplated that the adhesive can be applied by a suitable spray applicator to provide a thin uniform adhesive coating over the tough durable skin of the backing member. The backing member 100 may have a smooth surface finish that fits snuggly with the siding member 200, thereby increasing adhesive mileage and reducing adhesive quantities, with the resulting bond being stronger. In this way, it may not be necessary to completely cover the backing member 100 with adhesive in order to suitably join the backing member 100 and the siding member 200. Suitable materials for the adhesive include continuously flexible non-latex adhesives, such as thermoplastic PSAs, UV curable adhesives and hot melt adhesives, such as polyamines and urethanes, glue, thermosetting or thermoplastic adhesives, or pressure sensitive adhesives. Non-limiting examples of suitable spray thermoplastic adhesive coating materials include those commercially available from National Starch under the trade name DUROTAK, or available from Henckel under the trade name PURHM QR9011.

Deposition of the adhesive coating 150 can be by any suitable method with methods that reduce or eliminate telegraphing through the overlying siding member being preferred. Thus, spray deposition can be utilized as well as methods such as extrusion, roller coating, curtain coating, and the like.

The composite siding panels and siding assemblies disclosed herein may include additional features, as will be appreciated by those skilled in the art. For example, the opposing first and second side edges of the backing member can include an interlocking tab and slot arrangement. As another example, the backing member 100 can include drainage grooves in the front face or rear face thereof.

The following examples are presented to illustrate the composite panels described herein, and are not intended to limit the present disclosure.

### EXAMPLES

### Example 1

A block of foam was molded, then aged for a listed time period (2 days, 5 days, 7 days, or 17 days). Profiled parts were then cut out of the foam block and further aged. The length of each profiled part (i.e. foam backing member) was measured daily for 22 days. Tables A1-D4 below provide the daily measurements (in inches) for each time period. The sample part designation is listed in the first column, and the days are listed in the first row.

The column labeled “max” is the maximum length of the foam backing member over the 22-day period. The maximum length was not always obtained on Day 1 of the 22-day period, as seen for example with parts AF, BB, CD, CM, CN, DK, and DL. However, the maximum length was always obtained by Day 3.

The column labeled “min” is the minimum length of the foam backing member over the 22-day period. The minimum length was not always obtained on Day 22 of the 22-day period or only on Day 22, as seen in almost all parts. Most notably, parts BE-BI and BK-BN obtained a minimum measured length on Day 10, with part BM differing in length by 0.1875 inches between Day 10 and Day 22.

In Tables E1-E8, the percent change in length was calculated in four different ways for each data set. The first way was the difference between maximum length and minimum length, divided by the maximum length. The second way was the difference between maximum length and Day 22 length, divided by the maximum length. The third way was the difference between Day 1 length and minimum length, divided by the Day 1 length. The fourth and final way was the difference between Day 1 length and Day 22 length, divided by the Day 1 length. As can be seen in these tables, there were some minor differences in the percent change, depending on which values were used.

TABLE A1

2-day foam block aging

| | | | | | | |
|---|---|---|---|---|---|---|
| Part / Day | 1 | 2 | 3 | 4 | 5 | 6 |
| AA | 145.25 | 145.25 | 145.1875 | 145.125 | 145.0625 | 145.125 |
| AB | 145.1875 | 145.1875 | 145.125 | 145.0625 | 145 | 145 |
| AC | 145.25 | 145.25 | 145.1875 | 145.125 | 145.0625 | 145 |
| AD | 145.375 | 145.25 | 145.25 | 145.1875 | 145.125 | 145.125 |
| AE | 145.25 | 145.25 | 145.1875 | 145.125 | 145.0625 | 145.0625 |
| AF | 145.1875 | 145.25 | 145.125 | 145.0625 | 145 | 145.0625 |
| AG | 145.125 | 145.125 | 145.0625 | 145 | 145 | 144.9375 |
| AH | 145.125 | 145.125 | 145.0625 | 145 | 145 | 144.9375 |
| AI | 145.1875 | 145.1875 | 145.125 | 145.0625 | 145 | 145 |
| AJ | 145.1875 | 145.1875 | 145.125 | 145.125 | 145.0625 | 145 |
| AK | 145.25 | 145.1875 | 145.125 | 145.0625 | 145 | 145 |
| AL | 145.125 | 145.125 | 145.125 | 145 | 145 | 145 |
| AM | 145.125 | 145.125 | 145.125 | 145 | 145 | 144.9375 |
| AN | 145.1875 | 145.1875 | 145.125 | 145 | 145 | 145 |

TABLE A2

2-day foam block aging

| | | | | | | |
|---|---|---|---|---|---|---|
| Part / Day | 7 | 8 | 9 | 10 | 11 | 12 |
| AA | 145.0625 | 145.0625 | 145 | 145 | 145 | 145 |
| AB | 145 | 145 | 144.9375 | 144.9375 | 144.9375 | 144.9375 |
| AC | 145 | 145 | 145 | 145 | 144.9375 | 145 |
| AD | 145.125 | 145.0625 | 145.0625 | 145.125 | 145.125 | 145 |
| AE | 145 | 145 | 145 | 145 | 144.9375 | 144.9375 |
| AF | 145 | 145 | 145 | 144.9375 | 144.9375 | 144.9375 |
| AG | 144.9375 | 144.9375 | 144.875 | 144.875 | 144.875 | 144.875 |
| AH | 144.9375 | 144.9375 | 144.875 | 144.875 | 144.875 | 144.875 |
| AI | 145 | 144.9375 | 144.9375 | 144.9375 | 144.9375 | 144.875 |
| AJ | 145 | 145 | 145 | 145 | 145 | 144.9375 |
| AK | 145 | 145 | 144.9375 | 144.9375 | 144.9375 | 144.9375 |
| AL | 144.9375 | 145 | 144.9375 | 144.937 | 144.875 | 144.875 |
| AM | 144.9375 | 144.9375 | 144.875 | 144.875 | 144.875 | 144.875 |
| AN | 145 | 145 | 144.9375 | 144.9375 | 144.9375 | 144.9375 |

TABLE A3

2-day foam block aging

| | | | | | | |
|---|---|---|---|---|---|---|
| Part / Day | 13 | 14 | 15 | 16 | 17 | 18 |
| AA | 144.9375 | 144.9375 | 144.9375 | 144.9375 | 144.9375 | 144.9375 |
| AB | 144.9375 | 144.875 | 144.875 | 144.875 | 144.875 | 144.875 |
| AC | 144.98375 | 144.9375 | 144.9375 | 144.9375 | 144.875 | 144.9375 |
| AD | 145 | 145 | 145 | 145 | 145 | 145 |
| AE | 144.9375 | 144.9375 | 144.9375 | 144.875 | 144.9375 | 144.9375 |
| AF | 144.9375 | 144.9375 | 144.9375 | 144.875 | 144.875 | 144.9375 |
| AG | 144.875 | 144.875 | 144.875 | 144.8125 | 144.8125 | 144.875 |
| AH | 144.875 | 144.875 | 144.875 | 144.8125 | 144.8125 | 144.875 |
| AI | 144.9375 | 144.875 | 144.875 | 144.875 | 144.875 | 144.875 |
| AJ | 144.9375 | 144.9375 | 144.9375 | 144.875 | 144.875 | 144.875 |
| AK | 144.875 | 144.875 | 144.875 | 144.875 | 144.875 | 144.875 |
| AL | 144.875 | 144.875 | 144.875 | 144.875 | 144.875 | 144.875 |
| AM | 144.875 | 144.875 | 144.875 | 144.8125 | 144.8125 | 144.8125 |
| AN | 144.875 | 144.875 | 144.875 | 144.875 | 144.875 | 144.875 |

TABLE A4

2-day foam block aging

| | | | | | | |
|---|---|---|---|---|---|---|
| Part / Day | 19 | 20 | 21 | 22 | max | min |
| AA | 144.9375 | 144.875 | 144.875 | 144.875 | 145.25 | 144.875 |
| AB | 144.875 | 144.8125 | 144.8125 | 144.875 | 145.1875 | 144.8125 |
| AC | 144.875 | 144.875 | 144.875 | 144.875 | 145.25 | 144.875 |
| AD | 144.9375 | 144.9375 | 144.9375 | 144.9375 | 145.25 | 144.9375 |
| AE | 144.875 | 144.875 | 144.875 | 144.875 | 145.25 | 144.875 |
| AF | 144.875 | 144.8125 | 144.8125 | 144.875 | 145.25 | 144.8125 |
| AG | 144.8125 | 144.8125 | 144.75 | 144.8125 | 145.125 | 144.75 |
| AH | 144.8125 | 144.8125 | 144.75 | 144.8125 | 145.125 | 144.75 |
| AI | 144.875 | 144.8125 | 144.8125 | 144.8125 | 145.1875 | 144.8125 |
| AJ | 144.875 | 144.875 | 144.75 | 144.875 | 145.1875 | 144.75 |
| AK | 144.875 | 144.8125 | 144.8125 | 144.875 | 145.1875 | 144.8125 |
| AL | 144.8125 | 144.8125 | 144.8125 | 144.875 | 145.125 | 144.8125 |
| AM | 144.8125 | 144.75 | 144.8125 | 144.8125 | 145.125 | 144.75 |
| AN | 144.81254 | 144.8125 | 144.8125 | 144.875 | 145.1875 | 144.8125 |

TABLE B1

5-day foam block aging

| | | | | | | |
|---|---|---|---|---|---|---|
| Part / Day | 1 | 2 | 3 | 4 | 5 | 6 |
| BA | 145.375 | 145.3125 | 145.3125 | 145.25 | 145.1875 | 145.1875 |
| BB | 145.1875 | 145.375 | 145.125 | 145.0625 | 145.0625 | 145.0625 |
| BC | 145.3125 | 145.3125 | 145.3125 | 145.25 | 145.1875 | 145.125 |
| BD | 145.25 | 145.25 | 145.25 | 145.1875 | 145.125 | 145.125 |
| BE | 145.3125 | 145.3125 | 145.3125 | 145.25 | 145.1875 | 145.1875 |
| BF | 145.375 | 145.25 | 145.1875 | 145.1875 | 145.125 | 145.125 |
| BG | 145.3125 | 145.3125 | 145.25 | 145.1875 | 145.1875 | 145.125 |
| BH | 145.3125 | 145.3125 | 145.25 | 145.1875 | 145.125 | 145.125 |
| BI | 145.3125 | 145.3125 | 145.25 | 145.1875 | 145.125 | 145.125 |
| BJ | 145.375 | 145.375 | 145.3125 | 145.25 | 145.1875 | 145.125 |
| B | 145.375 | 145.3125 | 145.3125 | 145.25 | 145.1875 | 145.1875 |
| BL | 145.3125 | 145.3125 | 145.25 | 145.1875 | 145.125 | 145.125 |
| BM | 145.375 | 145.375 | 145.3125 | 145.25 | 145.1875 | 145.1875 |
| BN | 145.3125 | 145.3125 | 145.25 | 145.1875 | 145.125 | 145.125 |

TABLE B2

5-day foam block aging

| | | | | | | |
|---|---|---|---|---|---|---|
| Part / Day | 7 | 8 | 9 | 10 | 11 | 12 |
| BA | 145.1875 | 145.1875 | 145.1875 | 145.1875 | 145.125 | 145.125 |
| BB | 145.0625 | 145.0625 | 145 | 144.9375 | 145 | 145 |
| BC | 145.1875 | 145.1875 | 145.125 | 145 | 145.125 | 145.125 |
| BD | 145.125 | 145.125 | 145.125 | 145.125 | 145.0625 | 145.125 |
| BE | 145.1875 | 145.1875 | 145.125 | 145 | 145.125 | 145.125 |
| BF | 145.125 | 145.125 | 145.125 | 144.9375 | 145.0625 | 145.0625 |
| BG | 145.125 | 145.125 | 145.125 | 144.875 | 145.125 | 145.0625 |
| BH | 145.125 | 145.125 | 145.125 | 144.875 | 145.125 | 145.0625 |
| BI | 145.125 | 145.125 | 145.0625 | 144.9375 | 145.0625 | 145.0625 |
| BJ | 145.1875 | 145.1875 | 145.125 | 145 | 145.125 | 145.125 |
| B | 145.1875 | 145.1875 | 145.125 | 144.9375 | 145.125 | 145.125 |
| BL | 145.125 | 145.125 | 145.125 | 144.9375 | 145.0625 | 145.0625 |
| BM | 145.1875 | 145.1875 | 145.1875 | 144.875 | 145.125 | 145.125 |
| BN | 145.125 | 145.125 | 145.125 | 144.9375 | 145.0625 | 145.0625 |

TABLE B3

5-day foam block aging

| | | | | | | |
|---|---|---|---|---|---|---|
| Part / Day | 13 | 14 | 15 | 16 | 17 | 18 |
| BA | 145.125 | 145.125 | 145.125 | 145.0625 | 145.125 | 145.125 |
| BB | 145 | 145 | 145 | 144.9375 | 145 | 145 |
| BC | 145.0625 | 145.0625 | 145.0625 | 145.0625 | 145.0625 | 145.0625 |
| BD | 145.0625 | 145.0625 | 145.0625 | 145.0625 | 145.0625 | 145.0625 |
| BE | 145.125 | 145.125 | 145.125 | 145.0625 | 145.0625 | 145.0625 |
| BF | 145.0625 | 145.0625 | 145.0625 | 145 | 145 | 145 |
| BG | 145.0625 | 145.0625 | 145.0625 | 145 | 145.0625 | 145.0625 |
| BH | 145.0625 | 145.0625 | 145.0625 | 145 | 145.0625 | 145.0625 |
| BI | 145.0625 | 145.0625 | 145.0625 | 145 | 145 | 145 |
| BJ | 145.125 | 145.125 | 145.0625 | 145.0625 | 145.0625 | 145.0625 |
| B | 145.125 | 145.125 | 145.125 | 145.0625 | 145.0625 | 145.0625 |
| BL | 145.0625 | 145.0625 | 145.0625 | 145 | 145.0625 | 145.0625 |
| BM | 145.125 | 145.125 | 145.125 | 145.0625 | 145.0625 | 145.0625 |
| BN | 145.0625 | 145.0625 | 145.0625 | 145 | 145 | 145 |

TABLE B4

5-day foam block aging

| | | | | | | |
|---|---|---|---|---|---|---|
| Part / Day | 19 | 20 | 21 | 22 | max | min |
| BA | 145.0625 | 145.0625 | 145.0625 | 145.0625 | 145.3125 | 145.0625 |
| BB | 144.9375 | 144.9375 | 144.9375 | 144.9375 | 145.375 | 144.9375 |
| BC | 145 | 145 | 145 | 145.0625 | 145.3125 | 145 |
| BD | 145 | 145 | 145 | 145 | 145.25 | 145 |
| BE | 145.0625 | 145.0625 | 145.0625 | 145.0625 | 145.3125 | 145 |
| BF | 145 | 145 | 145 | 145 | 145.25 | 144.9375 |
| BG | 145 | 145 | 145 | 145 | 145.3125 | 144.875 |
| BH | 145 | 145 | 145 | 145 | 145.3125 | 144.875 |
| BI | 145 | 145 | 145 | 145 | 145.3125 | 144.9375 |
| BJ | 145.0625 | 145 | 145 | 145.0625 | 145.375 | 145 |
| B | 145.0625 | 145.0625 | 145 | 145.0625 | 145.3125 | 144.9375 |
| BL | 145 | 145 | 145 | 145 | 145.3125 | 144.9375 |
| BM | 145.0625 | 145.0625 | 145.0625 | 145.0625 | 145.375 | 144.875 |
| BN | 145 | 145 | 145 | 145 | 145.3125 | 144.9375 |

TABLE C1

7-day foam block aging

| | | | | | | |
|---|---|---|---|---|---|---|
| Part / Day | 1 | 2 | 3 | 4 | 5 | 6 |
| CA | 145.3125 | 145.3125 | 145.25 | 145.1875 | 145.125 | 145.125 |
| CB | 145.3125 | 145.3125 | 145.25 | 145.1875 | 145.125 | 145.125 |
| CC | 145.3125 | 145.3125 | 145.25 | 145.1875 | 145.125 | 145.125 |
| CD | 145.25 | 145.3125 | 145.25 | 145.1875 | 145.125 | 145.125 |
| CE | 145.25 | 145.25 | 145.25 | 145.125 | 145.125 | 145.125 |
| CF | 145.25 | 145.25 | 145.1875 | 145.125 | 145.0625 | 145.0625 |
| CG | 145.25 | 145.25 | 145.25 | 145.125 | 145.125 | 145.125 |
| CH | 145.3125 | 145.25 | 145.25 | 145.125 | 145.125 | 145.0625 |
| CI | 145.25 | 145.25 | 145.1875 | 145.125 | 145.0625 | 145.0625 |
| CJ | 145.25 | 145.25 | 145.1875 | 145.125 | 145.0625 | 145.0625 |
| CK | 145.25 | 145.25 | 145.1875 | 145.125 | 145.0625 | 145.0625 |
| CL | 145.25 | 145.25 | 145.25 | 145.125 | 145.125 | 145.125 |
| CM | 145.1875 | 145.25 | 145.1875 | 145.125 | 145.0625 | 145.0625 |
| CN | 145.1875 | 145.25 | 145.25 | 145.125 | 145.0625 | 145.0625 |

TABLE C2

7-day foam block aging

| | | | | | | |
|---|---|---|---|---|---|---|
| Part / Day | 7 | 8 | 9 | 10 | 11 | 12 |
| CA | 145.125 | 145.125 | 145.0625 | 145.0625 | 145.0625 | 145 |
| CB | 145.125 | 145.125 | 145.125 | 145.0625 | 145.0625 | 145.125 |
| CC | 145.125 | 145.125 | 145.0625 | 145.0625 | 145.0625 | 145.0625 |
| CD | 145.125 | 145.125 | 145.0625 | 145.0625 | 145.0625 | 145.0625 |
| CE | 145.0625 | 145.0625 | 145.0625 | 145 | 145 | 145 |
| CF | 145.0625 | 145.0625 | 145.0625 | 145 | 145 | 145 |
| CG | 145.125 | 145.0625 | 145.0625 | 145 | 145 | 145 |
| CH | 145.0625 | 145.0625 | 145.0625 | 145 | 145 | 145 |
| CI | 145.0625 | 145.0625 | 145 | 145 | 145 | 145 |
| CJ | 145.0625 | 145.0625 | 145 | 145 | 145 | 145 |
| CK | 145.0625 | 145.0625 | 145 | 145 | 145 | 145 |
| CL | 145.125 | 145.125 | 145.0625 | 145.0625 | 145.0625 | 145 |
| CM | 145.0625 | 145.0625 | 145 | 145 | 145 | 145 |
| CN | 145.0625 | 145.0625 | 145 | 145 | 145 | 145 |

TABLE C3

7-day foam block aging

| | | | | | | |
|---|---|---|---|---|---|---|
| Part / Day | 13 | 14 | 15 | 16 | 17 | 18 |
| CA | 145.0625 | 145.0625 | 145 | 145 | 145 | 145 |
| CB | 145.0625 | 145 | 145 | 145 | 145 | 145 |
| CC | 145.0625 | 145.0625 | 145 | 145 | 145 | 145 |
| CD | 145.0625 | 145 | 145 | 145 | 145 | 145 |
| CE | 145.0625 | 145 | 145 | 144.93756 | 145 | 144.9375 |
| CF | 145 | 145 | 144.9375 | 144.9375 | 144.9375 | 144.9375 |
| CG | 145 | 145 | 145 | 144.9375 | 144.9375 | 144.9375 |
| CH | 145 | 145 | 145 | 144.9375 | 144.9375 | 144.9375 |
| CI | 145 | 145 | 145 | 144.9375 | 144.9375 | 144.9375 |
| CJ | 145 | 144.9375 | 144.9375 | 144.9375 | 144.9375 | 144.9375 |
| CK | 145 | 145 | 144.9375 | 144.9375 | 144.9375 | 144.9375 |
| CL | 145 | 145 | 145 | 145 | 145 | 145 |
| CM | 145 | 145 | 145 | 144.9375 | 144.9375 | 145 |
| CN | 145 | 145 | 145 | 144.9375 | 144.9375 | 144.9375 |

TABLE C4

7-day foam block aging

| | | | | | | |
|---|---|---|---|---|---|---|
| Part / Day | 19 | 20 | 21 | 22 | max | min |
| CA | 145 | 144.9375 | 144.9375 | 144.9375 | 145.3125 | 144.9375 |
| CB | 145 | 144.9375 | 144.9375 | 145 | 145.3125 | 144.9375 |
| CC | 145 | 144.9375 | 144.9375 | 145 | 145.3125 | 144.9375 |
| CD | 145 | 144.9375 | 144.9375 | 144.9375 | 145.3125 | 144.9375 |
| CE | 144.9375 | 144.9375 | 144.9375 | 144.9375 | 145.25 | 144.9375 |
| CF | 144.9375 | 144.9375 | 144.9375 | 144.9375 | 145.25 | 144.9375 |
| CG | 144.9375 | 144.9375 | 144.9375 | 144.9375 | 145.25 | 144.9375 |
| CH | 144.9375 | 144.9375 | 144.9375 | 144.9375 | 145.3125 | 144.9375 |
| CI | 144.9375 | 144.875 | 144.875 | 144.9375 | 145.25 | 144.875 |
| CJ | 144.9375 | 144.875 | 144.875 | 144.9375 | 145.25 | 144.875 |
| CK | 144.9375 | 144.875 | 144.875 | 144.9375 | 145.25 | 144.875 |
| CL | 145 | 144.9375 | 144.9375 | 145 | 145.25 | 144.9375 |
| CM | 144.9375 | 144.875 | 144.875 | 144.9375 | 145.25 | 144.875 |
| CN | 144.9375 | 144.875 | 144.875 | 144.9375 | 145.25 | 144.875 |

TABLE D1

17-day foam block aging

| | | | | | | |
|---|---|---|---|---|---|---|
| Part / Day | 1 | 2 | 3 | 4 | 5 | 6 |
| DA | 145.25 | 145.25 | 145.25 | 145.1875 | 145.125 | 145.125 |
| DB | 145.3125 | 145.25 | 145.25 | 145.1875 | 145.125 | 145.125 |
| DC | 145.25 | 145.25 | 145.25 | 145.1875 | 145.125 | 145.125 |
| DD | 145.1875 | 145.1875 | 145.1875 | 145.125 | 145.0625 | 145.0625 |
| DE | 145.25 | 145.25 | 145.25 | 145.1875 | 145.125 | 145.125 |
| DF | 145.1875 | 145.1875 | 145.1875 | 145.125 | 145.125 | 145.0625 |
| DG | 145.1875 | 145.1875 | 145.1875 | 145.125 | 145.125 | 145.0625 |
| DH | 145.1875 | 145.1875 | 145.1875 | 145.125 | 145.125 | 145.0625 |
| DI | 145.1875 | 145.1875 | 145.1875 | 145.125 | 145.125 | 145.0625 |
| DJ | 145.25 | 145.25 | 145.25 | 145.1875 | 145.125 | 145.125 |
| DK | 145.125 | 145.0625 | 145.1875 | 145.0625 | 145.0625 | 145 |
| DL | 145.1875 | 145.1875 | 145.25 | 145.125 | 145.125 | 145.0625 |
| DM | 145.1875 | 145.1875 | 145.1875 | 145.125 | 145.0625 | 145.0625 |
| DN | 145.1875 | 145.1875 | 145.1875 | 145.125 | 145.0625 | 145.0625 |

TABLE D2

17-day foam block aging

| | | | | | | |
|---|---|---|---|---|---|---|
| Part / Day | 7 | 8 | 9 | 10 | 11 | 12 |
| DA | 145.125 | 145.125 | 145.125 | 145.125 | 145.0625 | 145.0625 |
| DB | 145.125 | 145.125 | 145.125 | 145.125 | 145.0625 | 145.0625 |
| DC | 145.125 | 145.125 | 145.125 | 145.0625 | 145.0625 | 145.0625 |
| DD | 145.125 | 145.0625 | 145.0625 | 145.0625 | 145.0625 | 145.0625 |
| DE | 145.125 | 145.125 | 145.125 | 145.0625 | 145.0625 | 145.0625 |
| DF | 145.0625 | 145.0625 | 145.0625 | 145 | 145 | 145.0625 |
| DG | 145.125 | 145.0625 | 145.0625 | 145.0625 | 145.0625 | 145.0625 |
| DH | 145.125 | 145.0625 | 145.0625 | 145 | 145 | 145 |
| DI | 145.125 | 145.0625 | 145.0625 | 145.0625 | 145 | 145 |
| DJ | 145.125 | 145.125 | 145.0625 | 145.0625 | 145.0625 | 145.0625 |
| DK | 145 | 145 | 145.0625 | 145 | 144.9375 | 144.9375 |
| DL | 145.125 | 145.0625 | 145 | 145.0625 | 145 | 145.0625 |
| DM | 145.0625 | 145.0625 | 145 | 145 | 145 | 145 |
| DN | 145.125 | 145.0625 | 145.0625 | 145 | 145.0625 | 145 |

TABLE D3

17-day foam block aging

| | | | | | | |
|---|---|---|---|---|---|---|
| Part / Day | 13 | 14 | 15 | 16 | 17 | 18 |
| DA | 145.0625 | 145.0625 | 145.0625 | 145 | 145.0625 | 145 |
| DB | 145.125 | 145.0625 | 145.0625 | 145.0625 | 145.0625 | 145.0625 |
| DC | 145.0625 | 145.0625 | 145.0625 | 145 | 145 | 145 |
| DD | 145.0625 | 145.0625 | 145.0625 | 145 | 145 | 145 |
| DE | 145.0625 | 145.0625 | 145.0625 | 145 | 145 | 145 |
| DF | 145 | 145 | 145 | 145 | 145 | 145 |
| DG | 145.0625 | 145.0625 | 145.0625 | 145 | 145 | 145 |
| DH | 145 | 145 | 145 | 145 | 145 | 145 |
| DI | 145 | 145 | 145 | 144.9375 | 145 | 145 |
| DJ | 145.0625 | 145.0625 | 145.0625 | 145 | 145 | 145 |
| DK | 144.9375 | 144.9375 | 144.9375 | 144.9375 | 144.9375 | 144.9375 |
| DL | 145.0625 | 145 | 145 | 145 | 145 | 145 |
| DM | 145 | 145 | 145 | 144.9375 | 144.9375 | 145 |
| DN | 145.0625 | 145 | 145 | 145 | 145 | 145 |

TABLE D4

17-day foam block aging

| | | | | | | |
|---|---|---|---|---|---|---|
| Part / Day | 19 | 20 | 21 | 22 | max | min |
| DA | 145 | 145 | 145 | 145 | 145.25 | 145 |
| DB | 145.0625 | 145 | 145 | 145.0625 | 145.3125 | 145 |
| DC | 145 | 145 | 145 | 145 | 145.25 | 145 |
| DD | 145 | 145 | 145 | 145 | 145.1875 | 145 |
| DE | 145 | 145 | 145 | 145 | 145.25 | 145 |
| DF | 145 | 144.9375 | 144.9375 | 144.9375 | 145.1875 | 144.9375 |
| DG | 145 | 145 | 145 | 145 | 145.1875 | 145 |
| DH | 144.9375 | 144.9375 | 144.9375 | 144.9375 | 145.1875 | 144.9375 |
| DI | 145 | 144.9375 | 144.9375 | 145 | 145.1875 | 144.9375 |
| DJ | 145 | 145 | 145 | 145 | 145.25 | 145 |
| DK | 144.9375 | 144.875 | 144.875 | 144.9375 | 145.1875 | 144.875 |
| DL | 145 | 144.9375 | 144.9375 | 145 | 145.25 | 144.9375 |
| DM | 144.9375 | 144.9375 | 144.9375 | 144.9375 | 145.1875 | 144.9375 |
| DN | 145 | 144.9375 | 144.9375 | 144.9375 | 145.1875 | 144.9375 |

TABLE E1

2-day foam block aging

| Test Part/Day | max length | min length | Day 1 length | Day 22 length |
|---|---|---|---|---|
| AA | 145.25 | 144.875 | 145.25 | 144.875 |
| AB | 145.1875 | 144.8125 | 145.1875 | 144.875 |
| AC | 145.25 | 144.875 | 145.25 | 144.875 |
| AD | 145.375 | 144.9375 | 145.375 | 144.9375 |
| AE | 145.25 | 144.875 | 145.25 | 144.875 |
| AF | 145.25 | 144.8125 | 145.1875 | 144.875 |
| AG | 145.125 | 144.75 | 145.125 | 144.8125 |
| AH | 145.125 | 144.75 | 145.125 | 144.8125 |
| AI | 145.1875 | 144.8125 | 145.1875 | 144.8125 |
| AJ | 145.1875 | 144.75 | 145.1875 | 144.875 |
| AK | 145.25 | 144.8125 | 145.25 | 144.875 |
| AL | 145.125 | 144.8125 | 145.125 | 144.875 |
| AM | 145.125 | 144.75 | 145.125 | 144.8125 |
| AN | 145.1875 | 144.8125 | 145.1875 | 144.875 |

TABLE E2

2-day foam block aging

| Test Part/Day | (max-min)/ max | (max-Day 22)/ max | (Day 1- min)/ Day 1 | (Day 1-Day 22)/ Day 1) |
|---|---|---|---|---|
| AA | 0.258% | 0.258% | 0.258% | 0.258% |
| AB | 0.258% | 0.215% | 0.258% | 0.215% |
| AC | 0.258% | 0.258% | 0.258% | 0.258% |
| AD | 0.301% | 0.301% | 0.301% | 0.301% |
| AE | 0.258% | 0.258% | 0.258% | 0.258% |
| AF | 0.301% | 0.258% | 0.258% | 0.215% |
| AG | 0.258% | 0.215% | 0.258% | 0.215% |
| AH | 0.258% | 0.215% | 0.258% | 0.215% |
| AI | 0.258% | 0.258% | 0.258% | 0.258% |
| AJ | 0.301% | 0.215% | 0.301% | 0.215% |
| AK | 0.301% | 0.258% | 0.301% | 0.258% |
| AL | 0.215% | 0.172% | 0.215% | 0.172% |
| AM | 0.258% | 0.215% | 0.258% | 0.215% |
| AN | 0.258% | 0.215% | 0.258% | 0.215% |

TABLE E3

5-day foam block aging

| Test Part/Day | max length | min length | Day 1 length | Day 22 length |
|---|---|---|---|---|
| BA | 145.375 | 145.0625 | 145.375 | 145.0625 |
| BB | 145.375 | 144.9375 | 145.1875 | 144.9375 |
| BC | 145.3125 | 145 | 145.3125 | 145.0625 |
| BD | 145.25 | 145 | 145.25 | 145 |
| BE | 145.3125 | 145 | 145.3125 | 145.0625 |
| BF | 145.375 | 144.9375 | 145.375 | 145 |
| BG | 145.3125 | 144.875 | 145.3125 | 145 |
| BH | 145.3125 | 144.875 | 145.3125 | 145 |
| BI | 145.3125 | 144.9375 | 145.3125 | 145 |
| BJ | 145.375 | 145 | 145.375 | 145.0625 |
| BK | 145.375 | 144.9375 | 145.375 | 145.0625 |
| BL | 145.3125 | 144.9375 | 145.3125 | 145 |
| BM | 145.375 | 144.875 | 145.375 | 145.0625 |
| BN | 145.3125 | 144.9375 | 145.3125 | 145 |

TABLE E4

5-day foam block aging

| Test Part/Day | (max-min)/ max | (max-Day 22)/ max | (Day 1- min)/ Day 1 | (Day 1-Day 22)/ Day 1) |
|---|---|---|---|---|
| BA | 0.215% | 0.215% | 0.215% | 0.215% |
| BB | 0.301% | 0.301% | 0.172% | 0.172% |
| BC | 0.215% | 0.172% | 0.215% | 0.172% |
| BD | 0.172% | 0.172% | 0.172% | 0.172% |
| BE | 0.215% | 0.172% | 0.215% | 0.172% |
| BF | 0.301% | 0.258% | 0.301% | 0.258% |
| BG | 0.301% | 0.215% | 0.301% | 0.215% |
| BH | 0.301% | 0.215% | 0.301% | 0.215% |
| BI | 0.258% | 0.215% | 0.258% | 0.215% |
| BJ | 0.258% | 0.215% | 0.258% | 0.215% |
| BK | 0.301% | 0.215% | 0.301% | 0.215% |
| BL | 0.258% | 0.215% | 0.258% | 0.215% |
| BM | 0.344% | 0.215% | 0.344% | 0.215% |
| BN | 0.258% | 0.215% | 0.258% | 0.215% |

TABLE E5

7-day foam block aging

| Test Part/Day | max length | min length | Day 1 length | Day 22 length |
|---|---|---|---|---|
| CA | 145.3125 | 144.9375 | 145.3125 | 144.9375 |
| CB | 145.3125 | 144.9375 | 145.3125 | 145 |
| CC | 145.3125 | 144.9375 | 145.3125 | 145 |
| CD | 145.3125 | 144.9375 | 145.25 | 144.9375 |
| CE | 145.25 | 144.9375 | 145.25 | 144.9375 |
| CF | 145.25 | 144.9375 | 145.25 | 144.9375 |
| CG | 145.25 | 144.9375 | 145.25 | 144.9375 |
| CH | 145.3125 | 144.9375 | 145.3125 | 144.9375 |
| CI | 145.25 | 144.875 | 145.25 | 144.9375 |
| CJ | 145.25 | 144.875 | 145.25 | 144.9375 |
| CK | 145.25 | 144.875 | 145.25 | 144.9375 |
| CL | 145.25 | 144.9375 | 145.25 | 145 |
| CM | 145.25 | 144.875 | 145.1875 | 144.9375 |
| CN | 145.25 | 144.875 | 145.1875 | 144.9375 |

TABLE E6

7-day foam block aging

| Test Part/Day | (max-min)/ max | (max-Day 22)/ max | (Day 1- min)/ Day 1 | (Day 1-Day 22)/ Day 1) |
|---|---|---|---|---|
| CA | 0.258% | 0.258% | 0.258% | 0.258% |
| CB | 0.258% | 0.215% | 0.258% | 0.215% |
| CC | 0.258% | 0.215% | 0.258% | 0.215% |
| CD | 0.258% | 0.258% | 0.215% | 0.215% |
| CE | 0.215% | 0.215% | 0.215% | 0.215% |
| CF | 0.215% | 0.215% | 0.215% | 0.215% |
| CG | 0.215% | 0.215% | 0.215% | 0.215% |
| CH | 0.258% | 0.258% | 0.258% | 0.258% |
| CI | 0.258% | 0.215% | 0.258% | 0.215% |
| CJ | 0.258% | 0.215% | 0.258% | 0.215% |
| CK | 0.258% | 0.215% | 0.258% | 0.215% |
| CL | 0.215% | 0.172% | 0.215% | 0.172% |
| CM | 0.258% | 0.215% | 0.215% | 0.172% |
| CN | 0.258% | 0.215% | 0.215% | 0.172% |

TABLE E7

17-day foam block aging

| Test Part/Day | max length | min length | Day 1 length | Day 22 length |
|---|---|---|---|---|
| DA | 145.25 | 145 | 145.25 | 145 |
| DB | 145.3125 | 145 | 145.3125 | 145.0625 |
| DC | 145.25 | 145 | 145.25 | 145 |
| DD | 145.1875 | 145 | 145.1875 | 145 |
| DE | 145.25 | 145 | 145.25 | 145 |
| DF | 145.1875 | 144.9375 | 145.1875 | 144.9375 |
| DG | 145.1875 | 145 | 145.1875 | 145 |
| DH | 145.1875 | 144.9375 | 145.1875 | 144.9375 |
| DI | 145.1875 | 144.9375 | 145.1875 | 145 |
| DJ | 145.25 | 145 | 145.25 | 145 |
| DK | 145.1875 | 144.875 | 145.125 | 144.9375 |
| DL | 145.25 | 144.9375 | 145.1875 | 145 |
| DM | 145.1875 | 144.9375 | 145.1875 | 144.9375 |
| DN | 145.1875 | 144.9375 | 145.1875 | 144.9375 |

TABLE E8

17-day foam block aging

| Test Part/Day | (max-min)/ max | (max-Day 22)/ max | (Day 1- min)/ Day 1 | (Day 1-Day 22)/ Day 1) |
|---|---|---|---|---|
| DA | 0.172% | 0.172% | 0.172% | 0.172% |
| DB | 0.215% | 0.172% | 0.215% | 0.172% |
| DC | 0.172% | 0.172% | 0.172% | 0.172% |
| DD | 0.129% | 0.129% | 0.129% | 0.129% |
| DE | 0.172% | 0.172% | 0.172% | 0.172% |
| DF | 0.172% | 0.172% | 0.172% | 0.172% |
| DG | 0.129% | 0.129% | 0.129% | 0.129% |
| DH | 0.172% | 0.172% | 0.172% | 0.172% |
| DI | 0.172% | 0.129% | 0.172% | 0.129% |
| DJ | 0.172% | 0.172% | 0.172% | 0.172% |
| DK | 0.215% | 0.172% | 0.172% | 0.129% |
| DL | 0.215% | 0.172% | 0.172% | 0.129% |
| DM | 0.172% | 0.172% | 0.172% | 0.172% |
| DN | 0.172% | 0.172% | 0.172% | 0.172% |

### Example 2

It has been found that controlling the release of moisture from the foam throughout the molding, cutting, and aging processes is important. At each stage through the process, the moisture content disperses out of the foam. Such “drying” of the foam beads creates minuscule amounts of shrinkage from each bead. Due to the foam backing member having so many beads along its length, the finished product can change dimensions up to 9/16-inch in length.

A foam block can be molded by filling a large cavity and infusing pre-expanded beads of material, then adding steam to the mold. When taken out of the mold, the foam block may have a moisture content of 6 wt% or greater After 48 hrs, the moisture content has usually changed less than 1% change from the block mold, i.e. a moisture content of about 5 wt% or greater Through the wire cutting process, an ~2 wt% change in moisture content may occur, for a total moisture content of about 3 wt% to about 4 wt%. After conditioning, the moisture content of the foam backing member will be less than 1 wt%.

### Example 3

Through each stage of the process (molding, cutting, and aging), the molecular glass transition temperature (Tg) of the foam may be described as “resetting”. Plastics have a “memory” that resets with each new Tg temperature reached. When the foam is cut using wire-cutting with hot wires, this creates a new Tg memory but the process is not long enough and does not use high enough temperatures to finish the “memory setting”. However, the conditioning process described herein which drives the remaining moisture out of the product does reset the “memory” of the foam due to the higher temperatures used. In laymen’s terms, this allows the foam to become pliable at a molecular level and causes the bead to be “fluid” enough to go back towards its smaller pre-expanded size. As a result, the length of the finished board may change up to 9/16-inch over a span of 12 feet to 16 feet.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A method for improving the stability of a foam backing member, comprising:
receiving a block of foam material;
cutting the block of foam material into a desired shape to obtain the foam backing member; and
conditioning the foam backing member until the length of the foam backing member has changed from an initial length by at least 0.15% or has a moisture content of less than 1 wt%.

2. The method of claim 1, wherein the conditioning occurs at a temperature of from room temperature to about 150° F.

3. The method of claim 1, wherein the conditioning occurs for a time period of about 3 days to about 30 days.

4. The method of claim 1, wherein the conditioning occurs for a time period of about 3 days to about 7 days at a temperature of about 130° F. to about 150° F.

5. The method of claim 1, wherein the conditioning occurs for a time period of about 20 days to about 30 days at room temperature.

6. The method of claim 1, wherein the initial length of the foam backing member is determined by measuring the length of the foam backing member a plurality of time over the first three days of aging, and selecting the longest measurement as the initial length.

7. The method of claim 1, wherein the length of the foam backing member has decreased from the initial length by 0.15% to about 0.30%.

8. The method of claim 1, wherein the block of foam material is aged before being cut.

9. The method of claim 8, wherein the aging of the foam block occurs at a temperature of from room temperature to about 150° F.

10. The method of claim 8, wherein the aging of the foam block occurs for a time period of about 1 day to about 20 days.

11. A method for preparing a composite siding panel with increased dimensional stability, comprising:
providing or receiving a foam backing member which has been dimensionally stabilized.;
laminating the foam backing member using an adhesive coating; and
attaching a siding member to the laminated foam backing member to form the composite siding panel.

12. The method of claim 11, wherein the foam backing member has been dimensionally stabilized when a length of the foam backing member has changed from an initial length by at least 0.15% or has a moisture content of less than 1 wt%.

13. A composite siding panel, comprising:
a foam backing member;
a siding member; and
an adhesive coating joining the siding member to the foam backing member;
wherein the foam backing member has been dimensionally stabilized before being joined to the siding member.

14. The composite siding panel of claim 13, wherein the foam backing member is shape-molded and composed of closed-cell expanded foam, or wherein the foam backing member is formed from wire-cut foam.

15. The composite siding panel of claim 13, wherein the siding member is formed from vinyl, polypropylene, aluminum, steel, fiberglass, engineered wood, or fiber cement.

16. The composite siding panel of claim 13, wherein the foam backing member has one or more contours defined therein and the siding member has one or more complementary-shaped contours defined therein.

17. The composite siding panel of claim 13, wherein the foam backing member has been dimensionally stabilized when a length of the foam backing member has changed from an initial length by at least 0.15%.

18. The composite siding panel of claim 13, wherein the dimensionally stabilized foam backing member has a moisture content of less than 1 wt%.
